(19) United States
(12) Patent Application Publication
(10) Pub. No.: US 2008/0163459 A1
(43) Pub. Date: Jul. 10, 2008

(54) Hinge having a stop to enhance closure effect

(75) Inventor: Tzu-Yu Lin, Shulin City (TW)

Correspondence Address: COOPER & DUNHAM, LLP, 1185 AVENUE OF THE AMERICAS, NEW YORK, NY, 10036, US

(73) Assignee: Shin Zu Shing Co., Ltd.

(21) Appl. No.: 11/650,369

(22) Filed: Jan. 5, 2007

(51) Int. Cl. E05D 11/06; E05D 15/30

(52) U.S. Cl. 16/345

(57) ABSTRACT

A hinge includes a pivoting shaft, an engaging plate having a connection plate adapted for firm connection to a monitor and a fixing sleeve firmly mounted around the pivoting shaft and selectively engaging with a top face of the connection plate to function as an urging element to prevent the connection plate from pivoting away from the connection extension such that when the monitor engages with the base, the engagement between the monitor and the base is secured.

### BACKGROUND OF THE INVENTION

1. Field of the Invention

The present invention relates to a hinge, and more particularly to a hinge having a stop selectively engaged with a limiting plate so as to enhance the closure effect when the hinge is pivoted in a predetermined direction.

2. Description of the Prior Art

A hinge is provided to help the pivotal movement between two objects, for example, a monitor and a base of a laptop computer. With the provision of the hinge, the user is able to easily pivot the monitor relative to the base. Similarly, the hinge provides a friction force to hold the monitor at a desired angle relative to the base so that the user is able to see the information on the monitor. When the user finishes using the laptop computer, the user pivots the monitor toward the base to close the laptop computer. After the laptop computer is closed, possible transportation of the laptop computer is doable in that either the monitor or the base is protected from damage. Otherwise, the laptop computer is easily damaged and destroyed.

However safe it may be, during transportation of the laptop computer, the hinge, most of the time, may not provide sufficient locking force to keep the monitor and the base close to each other. Therefore, an auxiliary locking device is needed to help close the monitor to the base. Adding an auxiliary locking device to the laptop computer does solve the problem though, manufacture cost is also increased.

To overcome the shortcomings, the present invention tends to provide an improved hinge to mitigate the aforementioned problems.

### SUMMARY OF THE INVENTION

The primary objective of the present invention is to provide an improved hinge to help enhance closure effect to eliminate the need of an auxiliary locking device to the laptop computer.

In order to accomplish the aforementioned objective, the hinge of the present invention includes a pivoting shaft, a positioning plate, an engaging plate and a fixing sleeve. The pivoting shaft is composed of a shaft and a connection extension. The shaft further has a shank integrally formed on a free end of the shaft. The positioning plate has a through hole defined to receive therein the shaft and a securing hole. The engaging plate is provided with a connection plate and two collars formed on a side face of the connection plate. The connection plate has a securing ledge integrally formed on one end of the connection plate to extend into the securing hole of the positioning plate and a limiting plate integrally formed on the other end of the connection plate to be opposite to the securing ledge. The fixing sleeve has a passage defined to receive therein the shank of the pivoting shaft and a stop formed on an outer periphery of the fixing sleeve to selectively engage with the limiting plate such that when the stop engages with the limiting plate, additional force is required to pivot the engaging plate toward the pivoting shaft, which enhances closure of the hinge.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the hinge in assembly;

FIG. 2 is an exploded perspective view of the hinge in FIG. 1;

FIG. 3 is an operational view showing that a monitor is pivoted away from the base via the hinge of the present invention; and

FIG. 4 is an operational view showing that the monitor is pivoted toward the base with the stop engages with the limiting plate.

### DETAILED DESCRIPTION OF THE PREFERRED EMBODIMENT

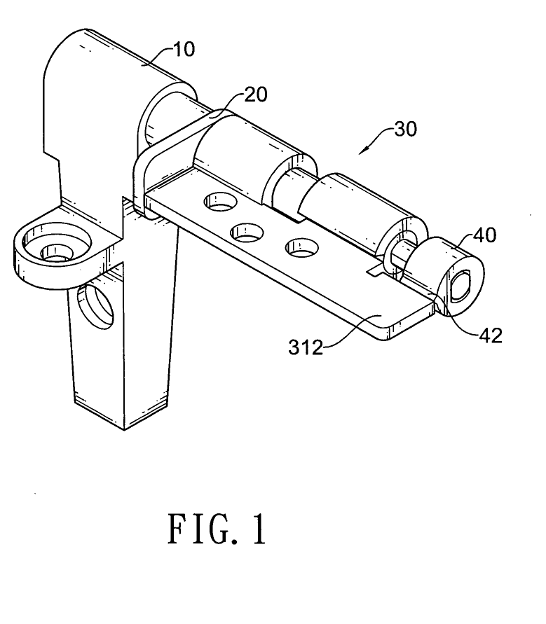

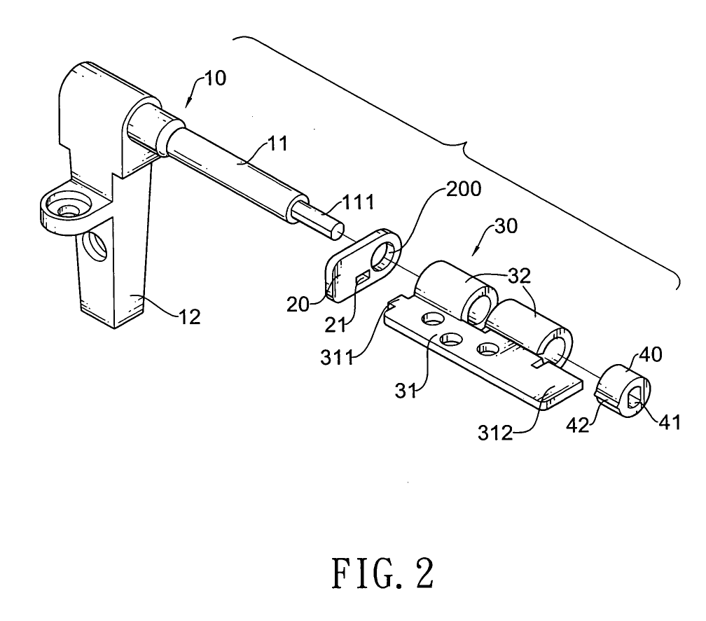

With reference to FIGS. 1 and 2, it is noted that the hinge constructed in accordance with the present invention include a pivoting shaft (10), a positioning plate (20), an engaging plate (30) and a fixing sleeve (40).

The pivoting shaft (10) is composed of a shaft (11) and a connection extension (12) vertically extending away from the shaft (11). The shaft (11) further has a shank (111) integrally extending from a free end of the shaft (11).

The positioning plate (20) has a through hole (200) defined to receive therein the shaft (11) and a securing hole (21) defined through the positioning plate (20).

The engaging plate (30) has a connection plate (31) and two hollow collars (32) integrally formed in series on a side face of the connection plate (31) and each hollow collar (32) has two open ends. At one end of the connection plate (31), a securing ledge (311) is formed to extend into the securing hole (21) of the positioning plate (20) and at the other end of the connection plate (31), a limiting plate (312) is integrally formed. Each of the two collars (32) is provided with a hole (not numbered) to receive therein the shaft (11) of the pivoting shaft (10) so that the shaft (11) is able to extend through the two collars (32) with the shank (111) extending out of the two collars (32). The fixing sleeve (40) has a passage (41) defined to receive therein the shank (111) and having a shape constructed in such a manner that after the shank (111) is received in the passage (41), relative movement of the fixing sleeve (40) to the shank (111) is impossible. That is, the shape of the shank (111) is substantially the same as that of the passage (41) with a slight difference in size so that after the shank (111) is extended into the passage (41), movement of the shank (111) drives the fixing sleeve (40) to move simultaneously. In addition, a stop (42) is longitudinally formed on an outer periphery of the fixing sleeve (40) to selectively engage with the limiting plate (312) of the engaging plate (30) when the engaging plate (30) pivots relative to the pivoting shaft (10).

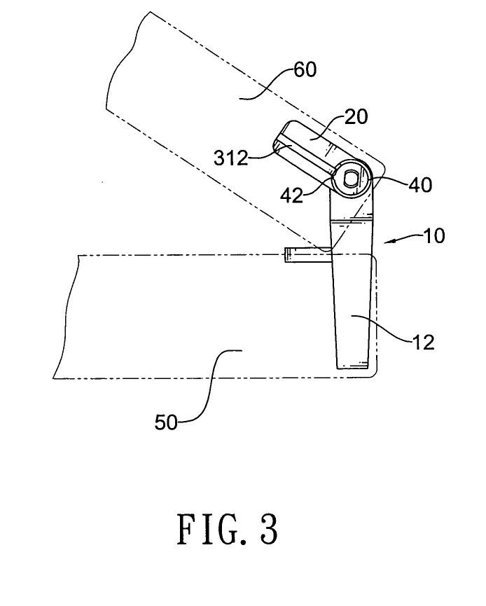

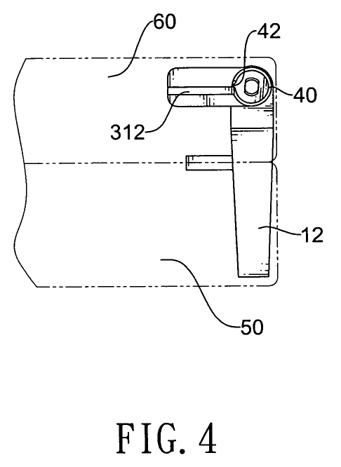

With reference to FIGS. 3 and 4, after the assembly of the hinge of the present invention is completed and the connection plate (31) of the engaging plate (30) is firmly connected to, for example, a monitor (60) and the connection extension (12) of the pivoting shaft (10) is firmly connected to, for example, a base (50), pivotal movement of the monitor (60) drives the engaging plate (30) to move accordingly and simultaneously. It is to be noted from FIG. 3 that when the monitor (60) is pivoted away from the base (50), the relative pivotal movement of the connection plate (31) relative to the fixing sleeve (40) allows the stop (42) to extend over the limiting plate (312). That is, when the connection plate (31) is pivoting away from the connection extension (12), the stop (42) is relatively moved to a bottom face of the limiting plate (312) to avoid hindering the opening of the monitor (60).

However, when the monitor (60) is pivoted toward the base (50), the limiting plate (312) slides over the stop (42) to allow the stop (42) to move to a top face of the limiting plate (312) to function as an urging element. That is to say, because the fixing sleeve (40) is firmly connected to the pivoting shaft (10) which, in turn is firmly connected to the base (50), when the monitor (60) is moved toward the base (50), the stop (4) on top of the limiting plate (312) prevents the limiting plate (312) as well as the connection plate (31) from moving away from the base (50). Due to the urging element, the stop (42), on top of the limiting plate (312), relative pivotal movement of the connection plate (31) to the pivoting shaft (10) is relatively hard and the user needs to exert additional force to overcome the urging force from the stop (42) to the limiting plate (312). Accordingly, the engagement between the monitor (60) and the base (50) is further enhanced.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A hinge consisting of:
a pivoting shaft composed of a shaft with a shank integrally formed on a free end of the shaft and a connection extension integrally extending out therefrom for firm connection to a base;
an engaging plate having a connection plate adapted for firm connection to a monitor which is able to pivot relative to the base and at least one collar formed on a side face of the connection plate and having a passage defined to receive therein the shaft such that the engaging plate is pivotally mounted around the shaft of the pivoting shaft; and
a fixing sleeve firmly mounted around the shank of the pivoting shaft and selectively engaging with a top face of the connection plate to function as an urging element to prevent the connection plate from pivoting away from the connection extension such that when the monitor engages with the base, the engagement between the monitor and the base is secured.

2. The hinge as claimed in claim 1, wherein the connection plate further has a limiting plate integrally formed with the connection plate and the fixing sleeve has a stop longitudinally formed on an outer periphery of the fixing sleeve to selectively engage with a top face of the limiting plate of the connection plate when the monitor is pivoted toward the base and with a bottom face of the limiting plate of the connection plate when the monitor is pivoted away from the base.

3. The hinge as claimed in claim 2 further comprising a positioning plate having a through hole defined to receive therein the shaft and a securing hole defined through the positioning plate so as to receive therein a securing ledge formed on a side face of the connection plate to be opposite to the limiting plate such that the positioning plate is securely and firmly connected to the engaging plate.

4. A hinge comprising:
a pivoting shaft composed of a shaft with a shank integrally formed on a free end of the shaft and a connection extension integrally extending out therefrom for firm connection to a base;
an engaging plate having a connection plate adapted for firm connection to a monitor which is able to pivot relative to the base and at least one collar formed on a side face of the connection plate and having a passage defined to receive therein the shaft such that the engaging plate is pivotally mounted around the shaft of the pivoting shaft; and
a fixing sleeve firmly mounted around the shank of the pivoting shaft and having a stop formed on an outer periphery of the fixing sleeve to selectively engaging with a top face and a bottom face of the connection plate to function as an urging element to prevent the connection plate from pivoting away from the connection extension such that when the monitor engages with the base, the engagement between the monitor and the base is secured.

5. The hinge as claimed in claim 4, wherein the connection plate further has a limiting plate integrally formed with the connection plate and the fixing sleeve has a stop longitudinally formed on an outer periphery of the fixing sleeve to selectively engage with a top face of the limiting plate of the connection plate when the monitor is pivoted toward the base and with a bottom face of the limiting plate of the connection plate when the monitor is pivoted away from the base.

6. The hinge as claimed in claim 5 further comprising a positioning plate having a through hole defined to receive therein the shaft and a securing hole defined through the positioning plate so as to receive therein a securing ledge formed on a side face of the connection plate to be opposite to the limiting plate such that the positioning plate is securely and firmly connected to the engaging plate.

7. A hinge comprising:
a pivoting shaft composed of a shaft with a shank integrally formed on a free end of the shaft and a connection extension integrally extending out therefrom for firm connection to a base;
an engaging plate having a connection plate adapted for firm connection to a monitor which is able to pivot relative to the base and at least one collar formed on a side face of the connection plate and having a passage defined to receive therein the shaft such that the engaging plate is pivotally mounted around the shaft of the pivoting shaft; and
a fixing sleeve firmly mounted around the shank of the pivoting shaft and having a stop formed on an outer periphery of the fixing sleeve to engage with a top face of the connection plate when the monitor is pivoted toward the base and to engage with a bottom face of the connection plate when the monitor is pivoted away from the base, such that when the monitor is pivoted toward the base, engagement between the monitor and the base is secured.

8. The hinge as claimed in claim 7, wherein the connection plate further has a limiting plate integrally formed with the connection plate and the fixing sleeve has a stop longitudinally formed on an outer periphery of the fixing sleeve to selectively engage with a top face of the limiting plate of the connection plate when the monitor is pivoted toward the base and with a bottom face of the limiting plate of the connection plate when the monitor is pivoted away from the base.

9. The hinge as claimed in claim 8 further comprising a positioning plate having a through hole defined to receive therein the shaft and a securing hole defined through the positioning plate so as to receive therein a securing ledge formed on a side face of the connection plate to be opposite to the limiting plate such that the positioning plate is securely and firmly connected to the engaging plate.
